(19) United States
(12) Patent Application Publication
(10) Pub. No.: US 2022/0292808 A1
(43) Pub. Date: Sep. 15, 2022

(54) METHOD AND SYSTEM FOR IDENTIFYING EMPTY REGION IN LABEL AND PLACING CONTENT THEREON

(71) Applicant: HCL Technologies Limited, New Delhi (IN)

(72) Inventors: HARIPRASATH J, Chennai (IN); NAVEEN SUBRAMANIAN, Chennai (IN); MURALI KRISHNAAN GAJAPATHY, Chennai (IN); YUVARAJAN SHANMUGASUNDARAM, Chennai (IN); NISHAR AHAMED, Chennai (IN)

(21) Appl. No.: 17/680,356

(22) Filed: Feb. 25, 2022

(30) Foreign Application Priority Data
Mar. 11, 2021 (IN) 202111010197

(51) Int. Cl. G06V 10/75

(52) U.S. Cl. CPC G06V 10/751; G06V 10/759; G06V 10/757; B41J 3/4075

(57) ABSTRACT

Method and system for identifying an empty region in a label and placing a content thereon is provided. The method includes processing an image of the label to extract label attribute and the content to retrieve content attribute. Label attribute includes at least one of dimensions of the label, at least one pre-existing content on the label, dimensions associated with pre-existing content, and location of pre-existing content on the label. The content attribute includes a type of content, dimensions of content, a preferred label location associated with content. The method further includes determining at least one empty region within the label, based on extracted label attribute and the retrieved content attribute. Each of the at least one empty region may be configured to accommodate the content. The method further includes inserting the content into one of the at least one empty region based on a predefined rule.

### TECHNICAL FIELD

This disclosure relates generally to extraction of information from images, and more particularly relates to identifying empty regions within labels for placing content thereon using image processing.

### BACKGROUND

Generally, labeling refers to labels and other written, printed, or graphic matter upon an article or containers, wrappers of the article (such as, but not limited to, a medical device and an automobile device). Typically, adding content in labeling (also referred as device labeling) may require manual effort for finding empty regions. Hence, the device labeling becomes a time-consuming process with increase in labeling operations. With automation of the device labeling, addition of new content may overlap with existing content within the label. As a result, automatically placed content may unintentionally cover or obscure an important information on the label, thereby negatively affecting user experience.

Accordingly, there is a need for a method and a system that can identify empty regions within the labels for accurate insertion of the content without manual intervention and additional hardware.

### SUMMARY

In an embodiment, a method for identifying an empty region in a label and placing a content thereon is disclosed. The method includes processing an image of the label to extract at least one label attribute and the content to retrieve at least one content attribute. The image may have a predefined ratio relative to the label. The at least one label attribute may include at least one of dimensions of the label, at least one pre-existing content on the label, dimensions associated with each of the at least one pre-existing content, and location of each of the at last one pre-existing content on the label. The at least one content attribute may include a type of the content, dimensions of the content, a preferred label location associated with the content. The method further includes determining at least one empty region within the label, based on the extracted at least one label attribute and the retrieved at least one content attribute. Each of the at least one empty region may be configured to accommodate the content. The method further includes inserting the content into one of the at least one empty region based on a predefined rule.

In another embodiment, a system for identifying an empty region in a label and placing a content thereon is disclosed. The system may include a processor and a memory communicatively coupled to the processor. The memory may be configured to store processor-executable instructions. The processor-executable instructions, on execution, cause the processor to process an image of the label to extract at least one label attribute and the content to retrieve at least one content attribute. The image may have a predefined ratio relative to the label. The at least one label attribute may include at least one of dimensions of the label, at least one pre-existing content on the label, dimensions associated with each of the at least one pre-existing content, and location of each of the at last one pre-existing content on the label. The at least one content attribute may include a type of the content, dimensions of the content, a preferred label location associated with the content. The processor instructions further cause the processor to determine at least one empty region within the label based on the extracted at least one label attribute and the retrieved at least one content attribute. Each of the at least one empty region may be configured to accommodate the content. The processor instructions further cause the processor to insert the content into one of the at least one empty region based on a predefined rule.

In yet another embodiment, a non-transitory computer-readable storage medium is disclosed. The non-transitory computer-readable storage medium has computer-executable instructions stored thereon for identifying an empty region in a label and placing a content thereon. The computer-executable instructions may cause a computer comprising one or more processors to perform operations that further include processing an image of the label to extract at least one label attribute and the content to retrieve at least one content attribute. The image may have a predefined ratio relative to the label. The at least one label attribute may include at least one of dimensions of the label, at least one pre-existing content on the label, dimensions associated with each of the at least one pre-existing content, and location of each of the at last one pre-existing content on the label. The at least one content attribute may include a type of the content, dimensions of the content, a preferred label location associated with the content. The operations may further include determining at least one empty region within the label based on the extracted at least one label attribute and the retrieved at least one content attribute. Each of the at least one empty region may be configured to accommodate the content. The operations may further include inserting the content into one of the at least one empty region based on a predefined rule.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram that illustrates an environment for an image processing system for identifying an empty region in a label to place content thereon, in accordance with an embodiment.

FIG. 2 is a functional block diagram that illustrates an exemplary image processing system for identifying an empty region in a label to place content thereon, in accordance with an embodiment.

FIGS. 3A and 3B collectively illustrate an exemplary image of a label used in device labeling for identifying an empty region in the label and placing content thereon, in accordance with an embodiment.

FIG. 4 is a flowchart that illustrates an exemplary method for identifying an empty region within a label to place content thereon, in accordance with an embodiment.

FIG. 5 is a flowchart that illustrates an exemplary method for determining at least one empty region within a label to place content thereon, in accordance with an embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The following described implementations may be found in the disclosed system and method for identifying an empty region in a label and placing a content thereon. The disclosed system may identify the empty region for inserting the content such that the content does not obscure salient pre-existing content within the label. The disclosed system may facilitate automatic labeling, such as, but not limited to, a medical device labeling and an automobile device labeling. Exemplary aspects of the disclosure provide a system that can identify the empty regions in an image for a label by using a relatively simple software algorithm with no additional hardware requirement. In accordance with an embodiment, a pixel-by-pixel comparison-based algorithm may be used for identifying one or more empty regions within the label. Therefore, memory requirement and a computational complexity of the disclosed system is very less.

The disclosed system may determine empty regions in a digital document (of a label) automatically which facilitates insertion of content (such as, texts and icons) in a device labeling process and a comment writing process without overlapping any pre-existing content. Therefore, the disclosed system and method may also facilitate content adding process with complete automation that requires no manual intervention. The disclosed system also facilitates region specific placement of the content in an image of the label based on a preferred label location. For example, an icon may be placed in an empty region adjacent to the preferred label location provided by a user (a content provider).

The disclosed system may facilitate removal of configuration steps from a user, removal of a requirement for the additional hardware, removal of manual errors (like overlapping the content over pre-existing content) and reliably ensuring that content may be accurately placed within the label. Also, automatic device labeling may speed up the labeling operation as compared to the manual device labeling.

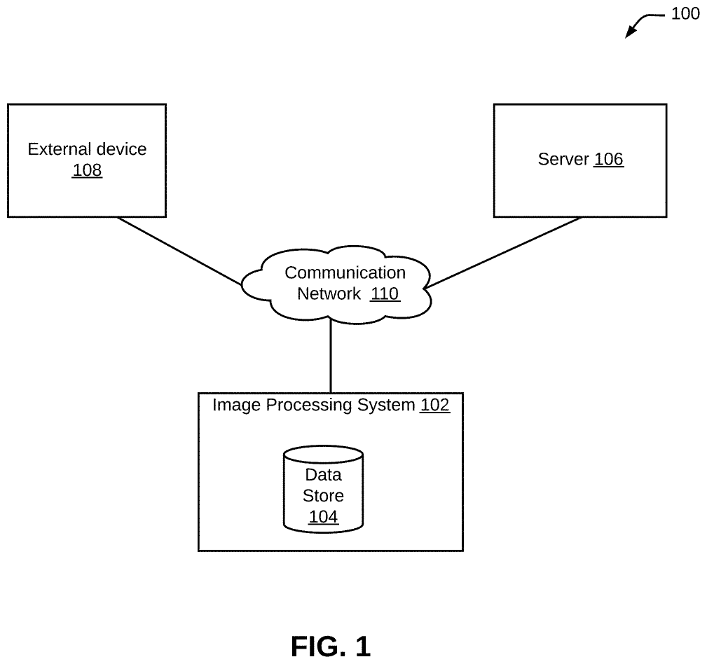

FIG. 1 is a block diagram that illustrates an environment 100 for an image processing system for identifying an empty region in a label to place content thereon, in accordance with an embodiment. The environment 100 includes an image processing system 102, a data store 104 within the image processing system 102, a server 106, an external device 108, and a communication network 110.

The image processing system 102 may be communicatively coupled to the server 106, and the external device 108, via the communication network 110. The image processing system 102 may include an application (not shown in FIG. 1) stored in a memory of the image processing system 102.

The image processing system 102 may include suitable logic, circuitry, interfaces, and/or code that may be configured to identify at least one empty region (hereinafter referred as an empty region) within a label for inserting content in the empty region of an image of the label. In accordance with an embodiment, the image may also correspond to a digital document for the label. The image processing system 102 may be configured to quantify identified empty regions. For example, the empty regions are quantified in terms of the dimensions of the content and the type of content that may be inserted within one of the empty regions. In accordance with an embodiment, the quantification may be a number of characters of text content in a certain point size that would fit in the empty region. In accordance with an embodiment, the image processing system 102 may be configured to process a plurality of images associated with different labels serially or in parallel to identify the empty regions within each of the plurality of images for placing the content.

In accordance with an embodiment, the image processing system 102 may use the application for application-specific deployment that includes software and/or logic to identify empty regions in an image of a label. By way of example, the image processing system 102 may be implemented as a plurality of distributed cloud-based resources by use of several technologies that are well known to those skilled in the art. In accordance with an embodiment, the image processing system 102 may include one or more dedicated computers. Other examples of implementation of the image processing system 102 may include, but are not limited to, a web/cloud server, an application server, a media server, and a Consumer Electronic (CE) device.

In accordance with an embodiment, the data store 104 may store the images received by the image processing system 102 and data associated with the images for access by users of the image processing system 102. For example, the data store 104 may store metadata along with the received images and may be accessed via the communication network 110.

In accordance with an embodiment, the data store 104 may store data structures for use in image processing of the images, for example, pixel intensity value index used for identifying the empty region(s) in the image, and the like. While the example of FIG. 1 includes a single data store (the data store 104) as part of the image processing system 102, it should be understood that data store 104 may also be located elsewhere in the environment 100. For example, a discrete storage device may be coupled with the image processing system 102, via a local connection or over the communication network 110.

The server 106 may include suitable logic, circuitry, interfaces, and/or code that may be configured to store, maintain, and execute one or more software platforms and programs, such as, one or more databases. Although in FIG. 1, the image processing system 102 and the server 106 are shown as two separate entities, this disclosure is not so limited. Accordingly, in some embodiments, the entire functionality of the server 106 may be included in the image processing system 102, without a deviation from scope of the disclosure.

The external device 108 may include suitable logic, circuitry, interfaces, and/or code that may be configured to transmit images of labels to the image processing system 102 for processing. The external device 108 may be capable of communicating with the image processing system 102 and the server 106 via the communication network 110. The external device 108 and the image processing system 102 are generally disparately located.

In accordance with an embodiment, the external device 108 may also be configured to represent the images of the labels in a format that is independent of methods that are utilized to capture or create those images. In accordance with an embodiment, images of the labels may include combinations of different types of content, such as, but not limited to, a text, an image, a graphics, a shape, an icon and/or barcodes. In accordance with an embodiment, the external device 108 may receive documents associated with the labels. In accordance with an embodiment, the documents may also include metadata, such as, but not limited to, a preferred location, a forbidden location, and reference fonts which are required to insert the content within the label.

In accordance with an embodiment, the external device 108 may also include a digital imaging part, e.g., an image sensor, such as, an active pixel sensor or a Charge Coupled Device (CCD), for capturing the images of the label. The image sensor may generate an image for the label which may be stored in an image buffer in memory of the image processing system 102 that is accessible by the application. The functionalities of the external device 108 may be implemented in portable devices, such as a high-speed computing device, and/or non-portable devices, such as an application server. Examples of the external device 108 may include, but are not limited to, a computing device, a smart phone, a camera, a mobile device, a laptop, a personal digital assistant (PDA), a printer and a tablet.

The communication network 110 may include a communication medium through which the image processing system 102, the server 106, and the external device 108 may communicate with each other. Examples of the communication network 110 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 110, in accordance with various wired and wireless communication protocols. Examples of such wired and wireless communication protocols may include, but are not limited to, a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

During operation, the image processing system 102 may receive one or more images for processing from the external device 108. In accordance with another embodiment, the image processing system 102 may receive the one or more images for processing from other sources, for example, an internet browser, email, or the like. In accordance with an embodiment, the image may have a predefined ratio relative to the label. In accordance with yet another embodiment, the image processing system 102 may also be configured to receive the label from the external device 108. Accordingly, the image processing system 102 may be configured to generate the image of the label from the label. The image processing system 102 may be configured to convert the image to a size that is of the predefined ratio relative to the label.

In accordance with an embodiment, the image processing system 102 may be further configured to process the image of the label to extract at least one label attribute and the content to retrieve at least one content attribute. The content and data associated with the at least one label attribute and the at least one content attribute may be stored in the data store 104. In accordance with an embodiment, at least one label attribute may include at least one of dimensions of the label, at least one pre-existing content on the label, dimensions associated with each of the at least one pre-existing content, and location of each of the at last one pre-existing content on the label. In accordance with an embodiment, the at least one content attribute may include a type of the content, dimensions of the content, a preferred label location associated with the content. In accordance with an embodiment, the image processing system 102 may be configured to retrieve the at least one content attribute from the content using an image processing algorithm.

In accordance with an embodiment, the image processing system 102 may be further configured to determine at least one empty region within the label based on the extracted at least one label attribute and the retrieved at least one content attribute. In accordance with an embodiment, each of the at least one empty region may be configured to accommodate the content. In accordance with an embodiment, the at least one empty region may be represented by a dotted line in the image of the label.

In accordance with an embodiment, the image processing system 102 may be further configured to insert the content into one of the at least one empty region based on a predefined rule. An example of the predefined rule may include that a user (content provider) has already chosen to place the content in a preferred label location and such preferred label location may be a part of metadata linked to the content. Accordingly, the image processing system 102 may check against such predefined rule to ensure that the content is placed into a suitable empty region. Thereby, the content may be automatically and preferably inserted in the suitable empty region of the image.

The predefined rule may also include labeling guidelines from a regulatory authority for positioning the content within a certain region of the label, based on the type of the content and an end product for affixing the label. In accordance with an embodiment, the labeling guidelines may also obscure certain regions in the label for positioning the content, based on the type of the content and an end product for affixing the label. Therefore, the image processing system 102 may automatically and preferably insert the content in the suitable empty region of the image without overlapping with the existing content.

While example embodiments described herein generally relate to determining empty regions in an image of the label for placing the content thereon, example embodiments may also be implemented for placing, without limitation, advertising banners and text advertisements based on identification of empty regions in web pages.

All the components in the environment 100 may be coupled directly or indirectly to the communication network 110. The components described in the environment 100 may be further broken down into more than one component and/or combined together in any suitable arrangement. Further, one or more components may be rearranged, changed, added, and/or removed.

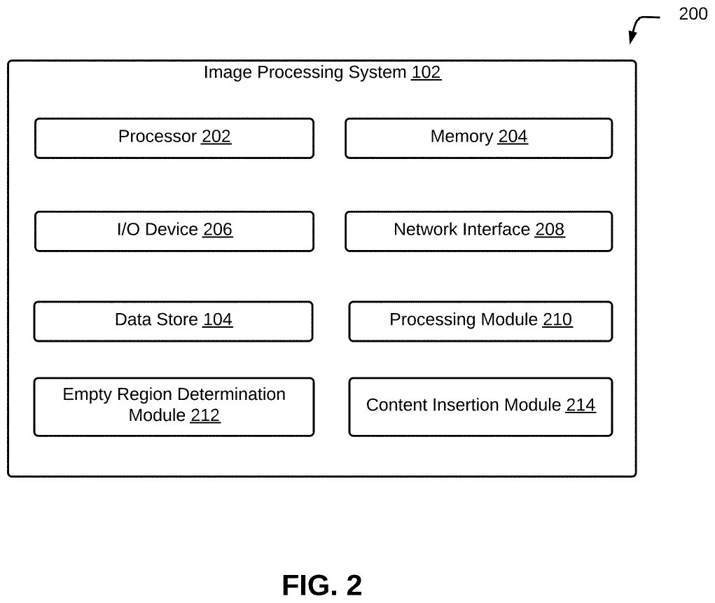

FIG. 2 is a functional block diagram that illustrates an exemplary image processing system for identifying an empty region in a label to place content thereon, in accordance with an embodiment. FIG. 2 is explained in conjunction with elements from FIG. 1.

With reference to FIG. 2, there is shown a functional block diagram 200 of the image processing system 102. The image processing system 102 may include a processor 202, a memory 204, an input/output (I/O) device 206, a network interface 208, a data store 104, a processing module 210, an empty region determination module 212, and a content insertion module 214.

The processor 202 may be communicatively coupled to the memory 204, the I/O device 206, the network interface 208, the datastore 104, the processing module 210, the empty region determination module 212, and the content insertion module 214. In one or more embodiments, the image processing system 102 may also include a provision/functionality to capture an image of a label via one or more external devices, for example, the external device 108.

Elements and features of the image processing system 102 may be operatively associated with one another, coupled to one another, or otherwise configured to cooperate with one another as needed to support the desired functionality, as described herein. For ease of illustration and clarity, the various physical, electrical, and logical couplings and interconnections for the elements and the features are not depicted in FIG. 2. Moreover, it should be appreciated that embodiments of image processing system 102 will include other elements, modules, and features that cooperate to support the desired functionality. For simplicity, FIG. 2 only depicts certain elements that relate to the techniques described in more detail below.

The processor 202 may include suitable logic, circuitry, interfaces, and/or code that may be configured to process images of the labels for device labeling operations and content addition operations. The processor 202 may be implemented based on a number of processor technologies, which may be known to one ordinarily skilled in the art. Examples of implementations of the processor 202 may be a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, Artificial Intelligence (AI) accelerator chips, a co-processor, a central processing unit (CPU), and/or a combination thereof. The processor 202 may be communicatively coupled to, and communicates with, the memory 204.

The memory 204 may include suitable logic, circuitry, and/or interfaces that may be configured to store instructions executable by the processor 202. Additionally, the memory 204 may be configured to store program code of one or more software applications that may incorporate the program code of the one or more image processing algorithms. The memory 204 may be configured to store any received data (such as, digital documents, images of the label) or generated data associated with storing, maintaining, and executing the image processing system 102 used to identify empty regions within the label. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may include suitable logic, circuitry, and/or interfaces that may be configured to act as an I/O interface between a user (such as, a content provider) and the image processing system 102. The I/O device 206 may include various input and output devices, which may be configured to communicate with different operational components of the image processing system 102. The I/O device 206 may be configured to communicate data between the image processing system 102 and one or more of the server 106, and the external device 108.

As described in more detail below, data received by the I/O device 206 may include, without limitation: images of the label, documents of the label, metadata of the label and data compatible with the image processing system 102. Data provided by the I/O device 206 may include, without limitation, content placement in identified empty regions within the label, and the like. Examples of the I/O device 206 may include, but are not limited to, a touch screen, a keyboard, a mouse, a joystick, a microphone, a printer, and a display screen.

The network interface 208 may include suitable logic, circuitry, interfaces, and/or code that may be configured to facilitate different components of the image processing system 102 to communicate with other devices, such as the server 106, and the external device 108, in the environment 100, via the communication network 110. The network interface 208 may be configured to implement known technologies to support wired or wireless communication. Components of the network interface 208 may include, but are not limited to an antenna, a radio frequency (RF) transceiver, one or more amplifiers, a tuner, one or more oscillators, a digital signal processor, a coder-decoder (CODEC) chipset, an identity module, and/or a local buffer.

The network interface 208 may be configured to communicate via offline and online wireless communication with networks, such as the Internet, an Intranet, and/or a wireless network, such as a cellular telephone network, a wireless local area network (WLAN), personal area network, and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), LTE, time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), Wi-MAX, Internet-of-Things (IoT) technology, Machine-Type-Communication (MTC) technology, a protocol for email, instant messaging, and/or Short Message Service (SMS).

The data store 106 may include suitable logic, circuitry, and/or interfaces that may be configured to store program instructions executable by the processor 202, the processing module 210, the empty region determination module 212, the content insertion module 214, operating systems, and/or application-specific information, such as application-specific databases. The data store 106 may include a computer-readable storage media for carrying or having computer-executable instructions or data structures stored thereon. Such computer-readable storage media may include any available media that may be accessed by a general-purpose or special-purpose computer, such as the processor 202, the processing module 210, the empty region determination module 212, and the content insertion module 214.

By way of example, and not limitation, the data store 104 may use computer-readable storage media that includes tangible or non-transitory computer-readable storage media including, but not limited to, Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media.

The processing module 210 may include suitable logic, circuitry, and/or interfaces that may be configured to process the image of the label to extract one or more label attributes and the content to retrieve one or more content attributes. The image may have a predefined ratio relative to the label. In accordance with another embodiment, the processing module 210 may be configured to generate the image of the label from the label. The processing module 210 may be further configured to convert the image to a size that is of the predefined ratio relative to the label. The one or more label attributes extracted by the processing module 210 may include at least one of dimensions of the label, at least one pre-existing content on the label, dimensions associated with each of the at least one pre-existing content, and location of each of the at last one pre-existing content on the label.

In accordance with an embodiment, the processing module 210 may be configured to extract the one or more label attributes that further includes pixel values associated with each pixel within the image of the label. In accordance with an embodiment, the processing module 210 may be configured to process the image of the label that further includes extracting the pixel values using a pixel-by-pixel comparison-based algorithm. In accordance with an embodiment, the processing module 210 may be configured to retrieve one or more content attributes that include a type of the content, dimensions of the content, a preferred label location associated with the content. In accordance with an embodiment, the processing module 210 may be configured to process the content to retrieve the one or more content attributes from a library of images. In accordance with an embodiment, the library of images may include mapping of a plurality of contents with associated content attributes.

The empty region determination module 212 may include suitable logic, circuitry, and/or interfaces that may be configured to determine at least one empty region within the label based on the extracted one or more label attributes and the retrieved one or more content attributes. In accordance with an embodiment, each of the at least one empty region may be configured to accommodate the content.

In accordance with an embodiment, the empty region determination module 212 may be configured to determine an empty region from the at least one empty region within the label comprises determining a set of contiguous pixels. In accordance with an embodiment, each pixel in the set of contiguous pixels may have a predefined pixel value. The predefined pixel value may correspond to a pixel value for an empty region. The empty region may include the set of contiguous pixels.

In accordance with an embodiment, the empty region determination module 212 may be further configured to identify a set of empty regions in the image of the label. The empty region determination module 212 may be further configured to quantify dimensions of each of the set of empty regions. The empty region determination module 212 may be further configured to compare dimensions of each of the set of empty regions with the dimensions of the content. In accordance with an embodiment, the empty region determination module 212 may be further configured to identify the at least one empty region from the set of empty regions. Dimensions of each of the at least one empty region may be greater than or equal to the dimensions of the content.

In accordance with an embodiment, the empty region determination module 212 may be further configured to modify the dimensions of the content to match the dimensions of a largest empty region from the at least one empty region, when the dimensions of the content do not match with the dimensions of each of the at least one empty region.

The content insertion module 214 may include suitable logic, circuitry, and/or interfaces that may be configured to insert the content into one of the at least one empty region based on a predefined rule. In accordance with an embodiment, the predefined rule may include a first empty region from the at least one empty region being the preferred label location associated with the content. The preferred label location may be a part of metadata linked to the content. In accordance with an embodiment, the predefined rule may also include selecting a second empty region closest to the preferred label location associated with the content, when the preferred label location is unavailable within the label. In accordance with an embodiment, the predefined rule may further include labeling guidelines from a regulatory authority for positioning the content within a certain region of the label, based on the type of the content and an end product for affixing the label.

In practice, the processing module 210, the empty region determination module 212, and the content insertion module 214 may be implemented with (or cooperate with) the at least one processor 202 to perform at least some of the functions and operations described in more detail herein. In this regard, the processing module 210, the empty region determination module 212, and the content insertion module 214 may be realized as suitably written processing logic, application program code, or the like.

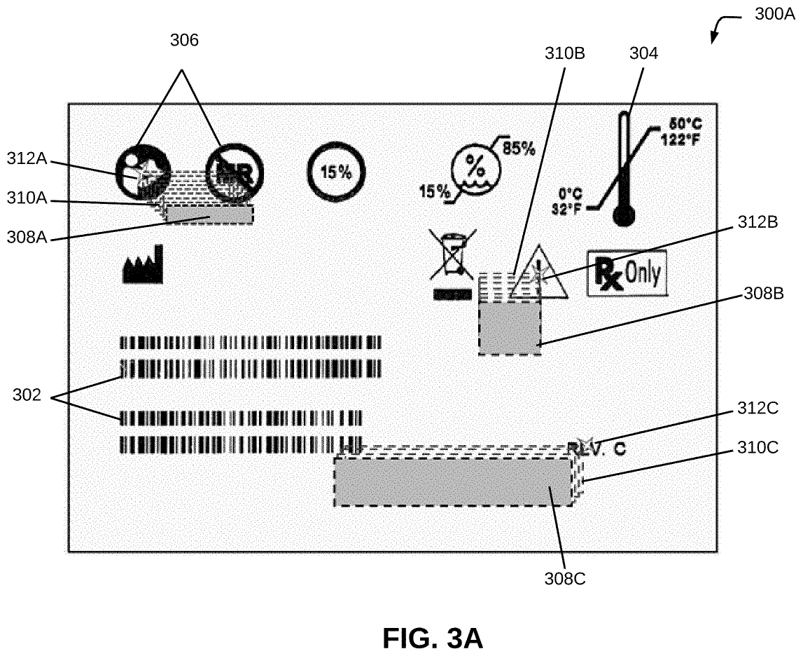

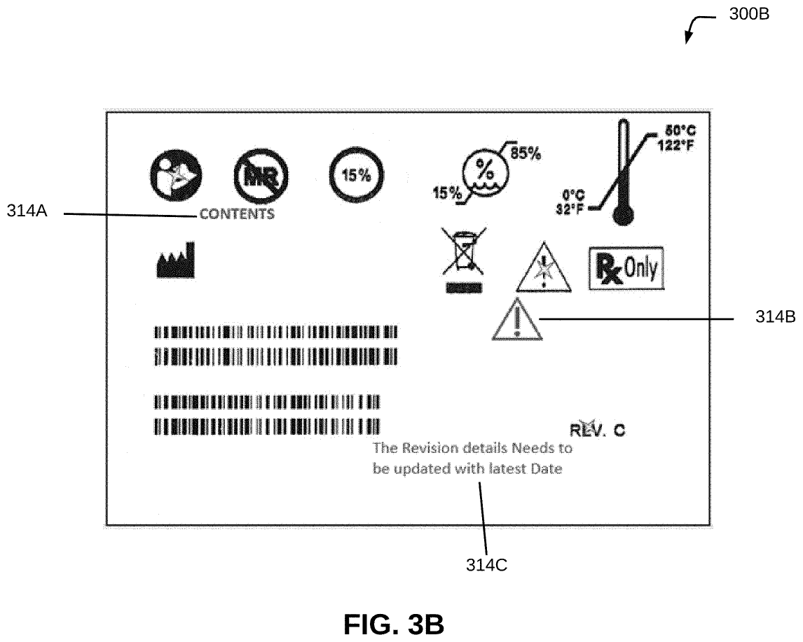

FIGS. 3A and 3B collectively illustrate an exemplary image of a label used in device labeling for identifying an empty region in the label and placing content thereon, in accordance with an embodiment. FIGS. 3A and 3B are explained in conjunction with elements from FIG. 1 and FIG. 2.

With reference to FIG. 3A, there is shown an image 300A of a label with pre-existing content, such as, barcodes 302 and a thermometer symbol 304 with temperature readings and icons 306. Some of the pre-existing content in the image 300A is not labelled for the sake of brevity. There is further shown empty regions 308A-308C, dotted lines 310A-310C associated with the empty regions 308A-308C and star symbols 312A-312C that signify preferred label locations associated with placement of the content. With reference to FIG. 3B that illustrates the image 300B (output image) of the label with insertion of the content, there is shown placement of the content 314A-314C within different empty regions 308A-308C of the label.

Referring to FIG. 3A, the image processing system 102 may be configured to receive an image, such as, the image 300A of a label from the external device 108. In accordance with an embodiment, the image processing system 102 may receive a document of the label from the external device and generate the image 300A of the label from the document. In accordance with another embodiment, the image processing system 102 may be configured to capture the image 300A of the label. The label may correspond to, without limitation, a medical device label, or an automobile label.

In accordance with an embodiment, the image processing system 102 may be configured to process the image 300A to extract label attribute(s) of the label associated with the image 300A. Such label attributes may include dimensions of the label and the image 300A may have a predefined ratio relative to the label. The pre-existing content of the label as shown in the image 300A, such as, the barcodes 302, the thermometer symbol 304 and the icons 306 may also correspond to label attributes.

In accordance with an embodiment, the label attribute may also include dimensions (size) of the barcodes 302, the thermometer symbol 304 and the icons 306 or font size of pre-existing text if any (not labelled in FIG. 3A) in the image 300A. In accordance with an embodiment, the label attribute may also include the location of the pre-existing content in the image. The location of the pre-existing content may be given in terms of geometrical coordinates, such as x coordinates and y coordinates.

The image processing system 102 may be configured to receive the content that needs to be placed in an empty region of the image 300A, from the external device 108, via the communication network 110. In accordance with an embodiment, the image processing system 102 may be configured to process the content to retrieve one or more content attributes. In accordance with an embodiment, the content attribute may include a type of the content. Examples of the type of the content may include at least one of an icon, a text, an image, an emoji, a logo, a barcode or a shape.

Further, the content attributes may also include dimensions of the content, such as, a font size for text (content) or a size of an icon (content) that needs to be added within the label. In accordance with an embodiment, the content attributes may further include a preferred label location for insertion of the content within the label. In accordance with an embodiment, the preferred label location for insertion of the content may be provided to the image processing system 102 from a content provider, via the communication network 110.

The preferred label location of the content may be given in terms of geometrical coordinates, such as x coordinates and y coordinates in the image 300A of the label. In accordance with an embodiment, the preferred label location may be a part of metadata linked to the content. In certain cases, the preferred label location may not be provided by the content provider for the placement of the content. In such cases, the image processing system 102 may be configured to assume a starting location of the image 300A as a preferred label location to determine empty region within the label, adjacent to such preferred location.

In accordance with an embodiment, the label attribute may further include pixel values associated with each pixel within the image 300A of the label. An image, such as the image 300A may correspond to a two-dimensional array of values (pixels). Pixels may correspond to picture element intensity values. The image 300A may correspond to a grayscale image where the pixels are scalars indicating the intensity of each pixel value. In accordance with an embodiment, the image processing system 102 may be configured to separate the background and foreground in the image 300A, based on the intensity of each pixel value. In accordance with another embodiment, the image processing system 102 may also be configured to process a colored image, whose pixels may have values of three-color channels, viz., red, green, and blue.

The image processing system 102 may be configured to extract the pixel values from the image 300A of the label, using a pixel-by-pixel comparison-based algorithm. The image processing system 102 may be configured to select one or more contiguous image regions (referred as empty regions) with similar pixel values in the image 300A, using the pixel-by-pixel comparison-based algorithm. In other words, the image processing system 102 may be configured to determine a set of contiguous pixels in the image 300A to determine one or more empty regions 308 within the image 300A of the label. Therefore, no additional hardware may be required for device labeling process. In accordance with an embodiment, each pixel in the set of contiguous pixels may have a predefined pixel value (or grayscale values). In accordance with an embodiment, the empty region 308 may include the set of contiguous pixels.

Bounding boxes to represent the empty regions 308A-308C are shown for explanation purpose in FIG. 3A only and may not be visible after placement of the content within the image 300B of the label as will be explained in description of FIG. 3B. Similarly, dotted lines (310A-310C) are for illustration purpose that indicate whether the identified empty region overlaps with the pre-existing content and based on the overlap, new empty regions may be identified within the label. Furthermore, the image processing system 102 may be configured to implement the pixel-by-pixel comparison-based algorithm at an application level for determining empty regions within the label for placing the content thereon.

In accordance with an embodiment, the image processing system 102 may be configured to identify a set of empty regions (308A, 308B and 308C) in the image 300A of the label. The image processing system 102 may be further configured to quantify dimensions of each of the empty regions 300A, 300B and 300C. In accordance with an embodiment, the dimensions may correspond to height and width of the empty regions (308A-308C). The image processing system 102 may be further configured to compare the dimensions of the empty regions (308A-308C) with the dimensions of the content.

The image processing system 102 may be further configured to identify at least one empty region from empty regions (308A-308C) for placement of the content such that dimensions of each of the empty regions (308A-308C) may be greater than or equal to the dimensions of the content. For example, the dimensions of the content “The revision details need to be updated with latest date” are greater than the dimensions of the empty region 308A, but equal to the dimensions of the empty region 308C. Therefore, the image processing system 102 may be configured to identify the empty region 308C from the empty regions (308A-308C) for placement of the content “The revision details need to be updated with latest date” within the label.

Further, there may be a predefined rule for labeling guidelines from a regulatory authority for positioning the content within a certain region of the label. For example, the content “The revision details need to be updated with latest date” may be positioned at the bottom right side of the label, based on the type of the content and an end product (such as, a pharmaceutical labels) for affixing the label.

Further, based on mismatch of the dimensions of the content with the dimensions of each of empty regions (308A-308C), the image processing system 102 may be configured to modify the dimensions of the content so as to match the dimensions of a largest empty region from the empty regions (308A-308C). For example, the empty region 300C from the empty regions (308A-308C) is the preferred label location (shown by the star symbol 312C) associated with the content “The revision details need to be updated with latest date” 314C and the empty region 300B from the empty regions (308A-308C) is the preferred label location (shown by the star symbol 312B) associated with the content of type icon.

For placement of the content “CONTENTS” 314A in the remaining empty region 308B from the empty regions (308A-308C), the dimensions of the content are decreased in font size to match the dimensions of the empty region 308B because the dimensions of the content “CONTENTS” 314A are greater than the dimensions of the empty region 308B. In certain cases, the image processing system 102 may be configured to select another empty region closest to a preferred label location associated with the content, when the preferred label location is unavailable within the label.

In accordance with an embodiment, the image processing system 102 may be configured to insert the content 314A into the empty region 308A, the content 314B into the empty region 308B and the content 314C into the empty region 308C of the image 300B without overlapping with the pre-existing content, such as, the barcodes 302, the thermometer symbol 304 and the icons 306. In accordance with an embodiment, the empty regions (such as, the empty regions 308A-308C) may be configured to accommodate the content.

In accordance with an embodiment, the image processing system 102 may be configured to convert the image (such as, the image 300B) into a document format and transmit to the external device 108, via the communication network 110. The image processing system 102 may facilitate users (such as, content providers) to write comments in the image of the labels with ease, and receive an output image (such as, the image 300B) with less effort and can be used easily. The writing the comments in an image or placing the icons within the label becomes easy with automation of identifying the empty regions in labeling process, such as, a device labeling and an automobile labeling.

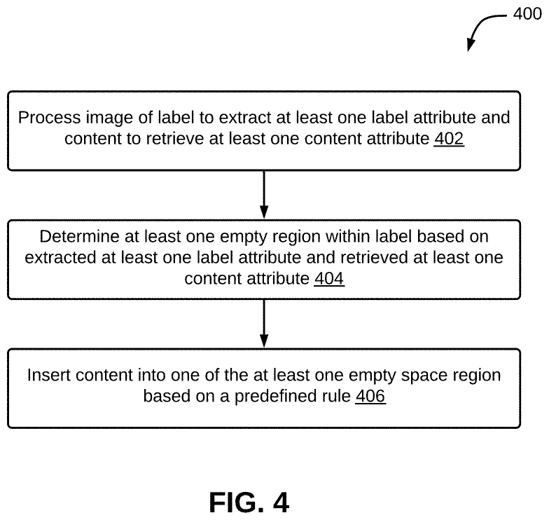

FIG. 4 is a flowchart that illustrates an exemplary method for identifying an empty region in a label and placing a content thereon, in accordance with an embodiment. With reference to FIG. 4, there is shown a flowchart 400. The operations of the exemplary method may be executed by any computing system, for example, by the image processing system 102 of FIG. 1. The operations of the flowchart 400 may start at 402 and proceed to 404.

At 402, an image of the label may be processed. In accordance with an embodiment, the processing module 210 of the image processing system 102 may be configured to process the image of the label to extract at least one label attribute and the content to retrieve at least one content attribute. In accordance with an embodiment, the image may have a predefined ratio relative to the label. In accordance with an embodiment, the processing module 210 may be configured to generate the image of the label from the label and convert the image to a size that is of the predefined ratio relative to the label.

In accordance with an embodiment, at least one label attribute may include at least one of dimensions of the label, at least one pre-existing content on the label, dimensions associated with each of the at least one pre-existing content, and location of each of the at last one pre-existing content on the label. In accordance with an embodiment, the at least one label attribute further may include pixel values associated with each pixel within the image of the label. In accordance with an embodiment, the processing module 210 may be configured to process the image of the label that further includes extracting the pixel values using a pixel-by-pixel comparison-based algorithm.

In accordance with an embodiment, the at least one content attribute may include a type of the content, dimensions of the content, a preferred label location associated with the content. In accordance with an embodiment, the at least one content attribute may be retrieved from the content by the processing module 210 using an image processing algorithm. In accordance with an embodiment, the at least one content attribute may be retrieved from a library of images by the processing module 210. In accordance with an embodiment, the library of images may include mapping of a plurality of contents with associated content attributes. The type of the content may include at least one of an icon, a text, an image, an emoji, a logo, or a shape.

At 404, at least one empty region may be determined within the label. In accordance with an embodiment, the empty region determination module 212 may be configured to determine at least one empty region within the label. Such determination may be based on the extracted at least one label attribute and the retrieved at least one content attribute. In accordance with an embodiment, each of the at least one empty region may be configured to accommodate the content.

In accordance with an embodiment, the empty region determination module 212 may be configured to determine an empty region from the at least one empty region within the label that includes determining a set of contiguous pixels. Each pixel in the set of contiguous pixels may have a predefined pixel value. The empty region may include the set of contiguous pixels. The predefined pixel value may correspond to a pixel value for an empty region.

At 406, the content may be inserted into one of the at least one empty region based on a predefined rule. In accordance with an embodiment, the content insertion module 214 of the image processing system 102 may be configured to insert the content into one of the at least one empty region based on the predefined rule.

The predefined rule may include a first empty region from the at least one empty region being the preferred label location associated with the content. The preferred label location may be a part of metadata linked to the content. The predefined rule may also include selecting a second empty region closest to the preferred label location associated with the content, when the preferred label location is unavailable within the label. The predefined rule may also include labeling guidelines from a regulatory authority for positioning the content within a certain region of the label, based on the type of the content and an end product for affixing the label.

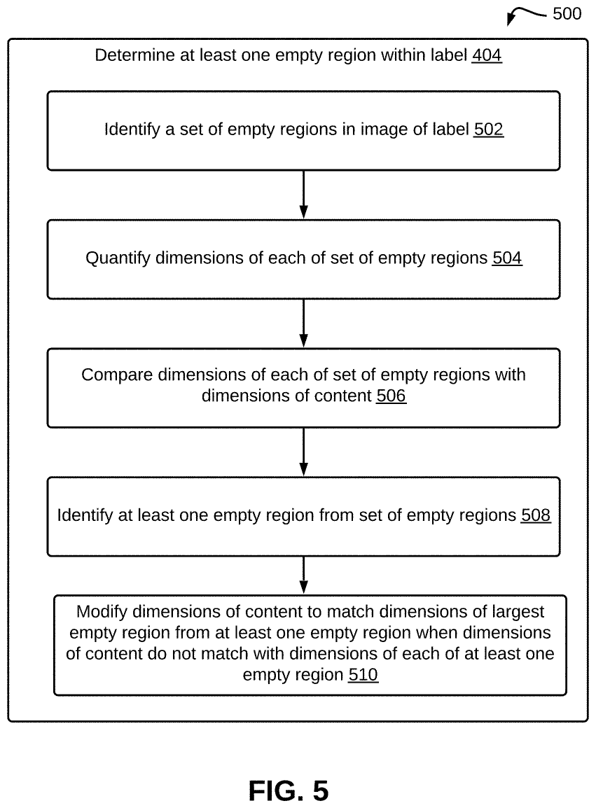

FIG. 5 is a flowchart that illustrates an exemplary method for determining at least one empty region in a label for placing a content thereon, in accordance with an embodiment. With reference to FIG. 5, there is shown a flowchart 500. The operations of the exemplary method may be executed by any computing system, for example, by the image processing system 102 of FIG. 1. The operations of the flowchart 500 may start at 502 and proceed to 504.

At 502, a set of empty regions may be identified in the image of the label. In accordance with an embodiment, the empty region determination module 212 may be configured to identify a set of empty regions in the image of the label. For example, a set of empty regions (308A-308C) is identified in the image 300A of the label as explained in description for FIG. 3A-3B.

At 504, dimensions of each of the set of empty regions may be quantified. In accordance with an embodiment, the empty region determination module 212 of the image processing system 102 may be configured to quantify dimensions of each of the set of empty regions.

At 506, dimensions of each of the set of empty regions may be compared with the dimensions of the content. In accordance with an embodiment, the empty region determination module 212 of the image processing system 102 may be configured to compare the dimensions of each of the set of empty regions with the dimensions of the content.

At 508, the at least one empty region may be identified from the set of empty regions. In accordance with an embodiment, the empty region determination module 212 of the image processing system 102 may be configured to identify the at least one empty region from the set of empty regions. In accordance with an embodiment, the dimensions of each of the at least one empty region may be greater than or equal to the dimensions of the content.

At 510, the dimensions of the content may be modified to match the dimensions of a largest empty region from the at least one empty region. In accordance with an embodiment, the empty region determination module 212 of the image processing system 102 may be configured to modify the dimensions of the content to match the dimensions of a largest empty region from the at least one empty region, when the dimensions of the content do not match with the dimensions of each of the at least one empty region.

The disclosed system may determine empty regions in a digital document (of a label) automatically which facilitates insertion of content (such as, texts and icons) in a device labeling process and a comment writing process without overlapping the pre-existing content. Therefore, the disclosed system and method may also facilitate content adding process with complete automation that requires no manual intervention. The disclosed system also facilitates region specific placement of the content in an image of the label based on a preferred label location. For example, an icon may be placed in an empty region adjacent to the preferred label location provided by a user (a content provider).

The disclosed system may facilitate removal of configuration steps from a user, removal of a requirement for the additional hardware, removal of manual errors (like overlapping the content over pre-existing content) and reliably ensuring that content may be accurately placed within the label. Also, automatic device labeling may speed up the labeling operation as compared to the manual device labeling.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It will be appreciated that, for clarity purposes, the above description has described embodiments with reference to different functional units and processors. However, it will be apparent that any suitable distribution of functionality between different functional units, processors or domains may be used without detracting from the disclosure. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present disclosure has been described in connection with some embodiments, it is not intended to be limited to the specific form set forth herein. Rather, the scope of the present disclosure is limited only by the claims. Additionally, although a feature may appear to be described in connection with particular embodiments, one skilled in the art would recognize that various features of the described embodiments may be combined in accordance with the disclosure.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for identifying an empty region in a label and placing a content thereon, the method comprising:
processing, by an image processing device, an image of the label to extract at least one label attribute and the content to retrieve at least one content attribute, wherein the image has a predefined ratio relative to the label, and
wherein at least one label attribute comprises at least one of dimensions of the label, at least one pre-existing content on the label, dimensions associated with each of the at least one pre-existing content, and location of each of the at last one pre-existing content on the label, and
wherein the at least one content attribute comprises a type of the content, dimensions of the content, a preferred label location associated with the content;
determining, by the image processing device, at least one empty region within the label based on the extracted at least one label attribute and the retrieved at least one content attribute, and wherein each of the at least one empty region is configured to accommodate the content; and
inserting, by the image processing device, the content into one of the at least one empty region based on a predefined rule.

2. The method of claim 1, wherein the predefined rule comprises at least one of:
a first empty region from the at least one empty region being the preferred label location associated with the content, wherein the preferred label location is part of metadata linked to the content;
selecting a second empty region closest to the preferred label location associated with the content, when the preferred label location is unavailable within the label; and
labeling guidelines from a regulatory authority for positioning the content within a certain region of the label, based on the type of the content and an end product for affixing the label.

3. The method of claim 1, wherein the at least one label attribute further comprises pixel values associated with each pixel within the image of the label, and wherein processing the image of the label further comprises extracting the pixel values using a pixel-by-pixel comparison-based algorithm.

4. The method of claim 3, wherein determining an empty region from the at least one empty region within the label comprises determining a set of contiguous pixels, wherein each pixel in the set of contiguous pixels has a predefined pixel value, and wherein the empty region comprises the set of contiguous pixels.

5. The method of claim 4, wherein determining at least one empty region comprises:
identifying a set of empty regions in the image of the label;
quantifying dimensions of each of the set of empty regions;
comparing dimensions of each of the set of empty regions with the dimensions of the content; and
identifying the at least one empty region from the set of empty regions, wherein dimensions of each of the at least one empty region is greater than or equal to the dimensions of the content.

6. The method of claim 5, further comprising modifying the dimensions of the content to match the dimensions of a largest empty region from the at least one empty region, when the dimensions of the content do not match with the dimensions of each of the at least one empty region.

7. The method of claim 1, wherein the at least one content attribute is retrieved from the content using an image processing algorithm.

8. The method of claim 1, wherein the at least one content attribute is retrieved from a library of images, and wherein the library of images comprises mapping of a plurality of contents with associated content attributes.

9. The method of claim 1, further comprising:
generating the image of the label from the label; and
converting the image to a size that is of the predefined ratio relative to the label.

10. The method of claim 1, wherein the type of the content comprises at least one of an icon, a text, an image, an emoji, a logo, or a shape.

11. A system for identifying an empty region in a label and placing a content thereon, the system comprising:
a processor; and
a memory communicatively coupled to the processor, wherein the memory stores processor-executable instructions, which, on execution, causes the processor to:
process an image of the label to extract at least one label attribute and the content to retrieve at least one content attribute, wherein the image has a predefined ratio relative to the label, and
wherein at least one label attribute comprises at least one of dimensions of the label, at least one pre-existing content on the label, dimensions associated with each of the at least one pre-existing content, and location of each of the at last one pre-existing content on the label, and
wherein the at least one content attribute comprises a type of the content, dimensions of the content, a preferred label location associated with the content;
determine at least one empty region within the label based on the extracted at least one label attribute and the retrieved at least one content attribute, and wherein each of the at least one empty region is configured to accommodate the content; and
insert the content into one of the at least one empty region based on a predefined rule.

12. The system of claim 11, wherein the predefined rule comprises at least one of:
a first empty region from the at least one empty region being the preferred label location associated with the content, wherein the preferred label location is part of metadata linked to the content;
selecting a second empty region closest to the preferred label location associated with the content, when the preferred label location is unavailable within the label; and
labeling guidelines from a regulatory authority for positioning the content within a certain region of the label, based on the type of the content and an end product for affixing the label.

13. The system of claim 11, wherein the at least one label attribute further comprises pixel values associated with each pixel within the image of the label, and wherein processing the image of the label further comprises extracting the pixel values using a pixel-by-pixel comparison-based algorithm.

14. The system of claim 13, wherein to determine an empty region from the at least one empty region within the label, the processor-executable instructions further cause the processor to determine a set of contiguous pixels, wherein each pixel in the set of contiguous pixels has a predefined pixel value, and wherein the empty region comprises the set of contiguous pixels.

15. The system of claim 14, wherein to determine at least one empty region, the processor-executable instructions further cause the processor to:
identify a set of empty regions in the image of the label;
quantify dimensions of each of the set of empty regions;
compare dimensions of each of the set of empty regions with the dimensions of the content; and
identify the at least one empty region from the set of empty regions, wherein dimensions of each of the at least one empty region is greater than or equal to the dimensions of the content.

16. The system of claim 15, wherein the processor-executable instructions further cause the processor to:
modify the dimensions of the content to match the dimensions of a largest empty region from the at least one empty region, when the dimensions of the content does not match with the dimensions of each of the at least one empty region.

17. The system of claim 11, wherein the at least one content attribute is retrieved from the content using an image processing algorithm.

18. The system of claim 11, wherein the at least one content attribute is retrieved from a library of images, and wherein the library of images comprises mapping of a plurality of contents with associated content attributes.

19. The system of claim 11, wherein the processor-executable instructions further cause the processor to:
generate the image of the label from the label; and
convert the image to a size that is of the predefined ratio relative to the label.

20. The system of claim 11, wherein the type of the content comprises at least one of an icon, a text, an image, an emoji, a logo, or a shape.

21. A non-transitory computer-readable medium storing computer-executable instruction for identifying an empty region in a label and placing a content thereon, the computer-executable instructions configured for:
processing an image of the label to extract at least one label attribute and the content to retrieve at least one content attribute, wherein the image has a predefined ratio relative to the label, and
wherein at least one label attribute comprises at least one of dimensions of the label, at least one pre-existing content on the label, dimensions associated with each of the at least one pre-existing content, and location of each of the at last one pre-existing content on the label, and
wherein the at least one content attribute comprises a type of the content, dimensions of the content, a preferred label location associated with the content;
determining at least one empty region within the label based on the extracted at least one label attribute and the retrieved at least one content attribute, and wherein each of the at least one empty region is configured to accommodate the content; and
inserting the content into one of the at least one empty region based on a predefined rule.
